(19) United States
(12) Patent Application Publication
(10) Pub. No.: US 2018/0207647 A1
(43) Pub. Date: Jul. 26, 2018

(54) Gold panning machine

(71) Applicant: James A. Yanez, Tucson, AZ (US)

(72) Inventor: James A. Yanez, Tucson, AZ (US)

(21) Appl. No.: 15/530,529

(22) Filed: Jan. 25, 2017

(51) Int. Cl. B03B 5/04

(52) U.S. Cl. CPC B03B 5/04

(57) ABSTRACT

A gold panning machine that works with or without water. A pan is attached to a transmission and motor like that in a clothes-washing machine. The transmission and motor oscillate the pan full of Gold-Bearing sand like the tub in a clothes-washing machine. The pan has a ring attached to it that prevents the gold from being thrown off by the centrifugal force caused by the oscillation. The gold concentrates in the bottom of the pan by gravity and the waste is discarded by centrifugal force.

### CROSS-REFERENCE TO RELATED APPLICATIONS

Not applicable

### FEDERALLY SPONSORED RESEARCH

Not applicable

### BACKGROUND

### Field of Invention

This invention relates to Gold concentrators of the pan type

### Prior Art

On this planet, there are many deposits of sand, gravel and dirt which contain particles of gold or other valuable minerals. For this exercise, I will talk about Gold in Sand. Many devices have been made to recover these minerals. One of them is a hand pan. Panning for gold with a hand pan is very effective but is slow and strenuous. Many machines have been devised in an attempt to duplicate the process. These machines rotate, wiggle and shake the sand in various ways and slosh it around with water in an attempt to duplicate what happens in a hand pan. These gyrations and sloshing around cause the gold to settle to the bottom of the pan because gold particles have a higher specific gravity than the particles in the surrounding sand. But when they mechanize to speed things up, they rotate the pan and subject the sand to centrifugal force. The outward pull of centrifugal force is far greater than the downward pull of gravity. Centrifugal force will pull some of the gold outward before it gets a chance to get to the bottom of the pan. This gold will be pulled over the edge of the pan and lost. This concentrator overcomes that problem.

### DRAWINGS

FIG. 1. Side view of one embodiment

FIG. 2. Enlarged view of the pan and ring assembly in perspective.

### DESCRIPTION

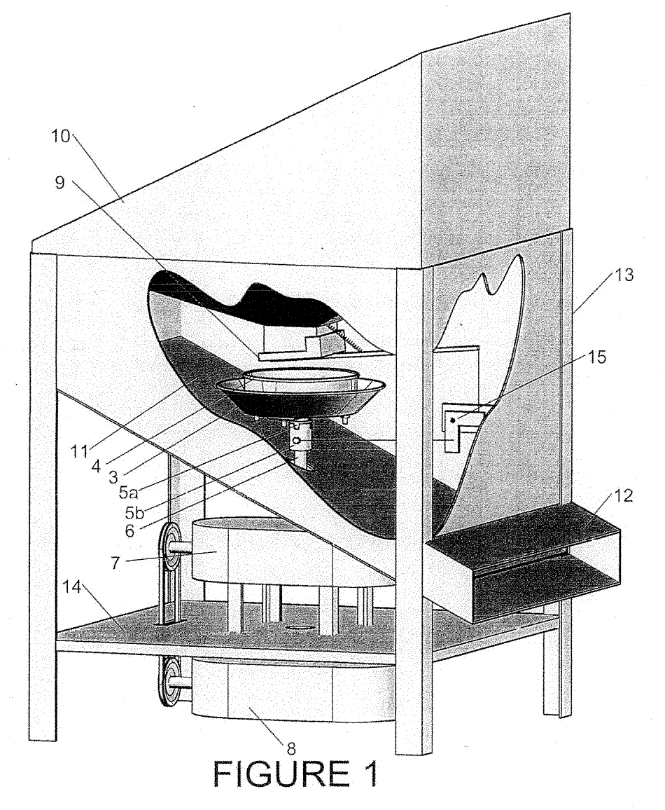

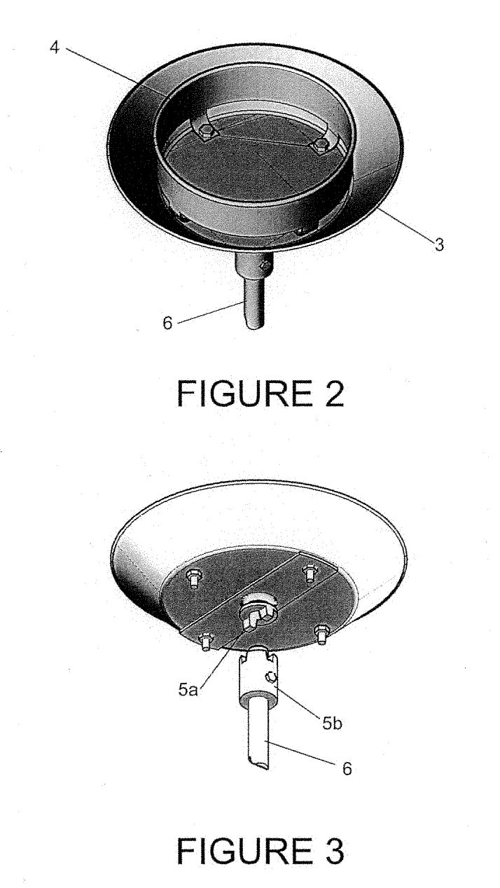

This machine has a pan 3 and ring 4 assembly shown in FIG. 1 and FIG. 2 which is attached to a shaft 6 by a coupling 5 which makes it easy to remove and replace the pan and ring assembly. The shaft is attached to a transmission 7 of a clothes washing machine or other similar gearing mechanism which is driven by a motor 8.

The motor and transmission cause the pan to oscillate like a tub in a clothes-washing machine.

The pan should have such a shape that the diameter of the rim is greater than the diameter of the bottom of the pan, as shown on the drawings. Conventional hand pans have that shape.

The ring 4 is attached to the center of the pan 3, as on stilts leaving a gap between the ring and the bottom of the pan. The ring is like a sauce pan with the bottom removed.

All in a housing suitable for holding all the parts together and allowing the waste to escape. Also with provision to feed the sand through a feeder 9 whose rate of feed can be adjusted.

### Operation

The gold-bearing sand is fed into the inside of the ring. With the machine running, the sand within the ring will move downward to the bottom and outwards. As the sand moves downward it is shaken so that the gold works its way down to the bottom as it would in a hand pan. As the sand moves downwards through the ring the gold will be pulled outwards by centrifugal force, but the ring keeps it going down.

Once the gold reaches the bottom of the pan it stays there. The gold cannot climb up out of the bottom to the outer edge of the pan because of its greater specific gravity. At the bottom of the pan, the centrifugal force is less than it would be at the top outer edge, without the ring. Centrifugal force is less so that the gold will not be pulled outwards to the top outer edge of the pan. The light barren sand moves outwards and upwards outside of the ring and is thrown off the pan by centrifugal force. The gold continues to concentrate on the bottom of the pan.

The operator will periodically remove the pan, empty it and return it to the machine To continue working. This machine works with or without the addition of water.

I claim:

1. A gold panning machine. Gold-bearing dirt or sand is fed into this machine and it passes through the machine and the gold stays in the machine, comprising:
(a) A motor.
(b) A transmission attached to and driven by the motor. The transmission has a shaft which protrudes upwards out of the transmission into a housing. The transmission is such that it causes the shaft to rotate in one direction for a partial rotation then reverses itself for a partial rotation, repeating this back and forth motion continuously.
(c) A pan and ring assembly consisting of:
(1) A pan.
(2) A ring which has a shape like a sauce pan with the bottom removed. This ring is attached to the pan, up from the bottom, as if on stilts,
leaving a gap between the bottom of the pan and the bottom of the ring.
This pan and ring assembly is attached to the shaft from the transmission in such a manner that it can be easily removed from and replaced onto the shaft.
(d) A housing.
This housing consists of an enclosure enclosing the area around the pan and ring Assembly, configured to confine the movement of sand when it leaves the pan and Having an opening at the bottom whereby the barren sand is discarded.
Said housing has legs and a framework to hold the motor and transmission
(e) A bin.
A bin capable of holding a quantity of sand. Said bin is positioned above the housing and pan and ring assembly so that the sand fed into it will funnel down into the pan And ring assembly.
Whereby gold can be removed from sand or dirt in a continuous process, unlike panning by hand which is a batch process.

2. (canceled)
